(19) United States
(12) Patent Application Publication
(10) Pub. No.: US 2007/0260348 A1
(43) Pub. Date: Nov. 8, 2007

(54) PORTABLE TABLE CARRIER FOR CONSTRUCTION PLANS

(76) Inventor: Ben Gordils, Ft. Lauderdale, FL (US)

Correspondence Address: McHale & Slavin, P.A, 2855 PGA Boulevard, Palm Beach Gardens, FL, 33410, US

(21) Appl. No.: 11/741,432

(22) Filed: Apr. 27, 2007

Related U.S. Application Data
(63) Continuation-in-part of application No. 11/004,602, filed on Dec. 3, 2004, now abandoned.
(60) Provisional application No. 60/527,549, filed on Dec. 5, 2003.

(51) Int. Cl. G06F 19/00

(52) U.S. Cl. 700/117

(57) ABSTRACT

A combination portable table and carrier device for transporting and reading construction plans (e.g. blueprints) is disclosed. The device includes a table having a plan storage compartment for holding one or more sets of construction plans in a flat or folded position. The storage compartment is flush with the surface of the table thus enabling the construction plans to be written on without problems from the underlying surface. A lid is hinged to the storage compartment and the table thus providing access to the storage compartment when open and a smooth work surface for the table when closed. The lid also protects the contents of the storage compartment when it is closed. Binder clips at opposite ends of the portable secure the set of construction plans in place for viewing and modification. The binder clips holds the turned pages of the plans, thereby permitting individual pages of the plans to be easily viewed while the entire set of plans is secured in place and held open to the selected page.

### RELATED APPLICATIONS

This application is a continuation in part of U.S. patent application Ser. No. 11/004,602, filed Dec. 3, 2004, which claims the benefit of the filing date of U.S. Provisional Application No. 60/527,549, filed Dec. 5, 2003 under 35 U.S.C. 119(e).

### FIELD OF THE INVENTION

The present invention relates to a portable table and more particularly, to a portable table including a carrying case which holds a set of construction plans and accessory devices, such as pens, pencils, rulers, calculators and the like and wherein the portable table is provided with folding legs for support of the table.

### BACKGROUND OF THE INVENTION

The construction of a building or home often involves a general contractor, along with numerous subcontractors such as framers, plumbers, electricians, carpenters, roofers and window installers. All of these individuals require a set of construction plans (e.g. blueprints) which provide the details of construction for the building or home and particularly the specifications relating to each phase of the construction. Each of the subcontractors will usually have a set of plans directed to the particular work being performed by that subcontractor. The general contractor requires a full set of plans detailing all phases of the construction project. Typically, construction plans are printed on large rectangular sheets, in sets ranging from five sheets to more than twenty sheets. The sheets in each set of plans are bound together along a side binding.

During the course of construction, the general contractor as well as all of the subcontractors must routinely refer to their plans, on the job site, in order to confirm that the work being performed is in accordance with the specifications in the plans. Due to the harsh nature of construction sites, it is often difficult to find a suitable work surface which allows the construction plans to be opened, spread flat and readily viewed. When working outdoors or in open structures, gusts of wind make it difficult to hold the plans open to any particular page. It is therefore not surprising to find one or more individuals at a typical construction site struggling to read construction plans on makeshift surfaces, such as on the top of a stack of building materials.

### DESCRIPTION OF THE PRIOR ART

U.S. Pat. No. 6,068,355, issued to Thorp discloses a portable workstation which is foldable into a transportable unit including top and bottom parts hingedly connected to one another. A table top is disposed atop the bottom part and defines an upwardly facing work surface. The table top and bottom part together define an interior compartment for storing objects therein. Legs are hingedly connected to the lower portion of the bottom part. The legs are adjustable to support the workstation at different heights. The top portion must be swung open and the drawer removed prior to being able to utilize the table of the work station. The present invention provides access to the table without the need to open or remove any compartments.

U.S. Pat. No. 5,281,019, issued to Rodeck discloses a carrying case for plans which can be unfolded to provide a table or flat surface on which the plans may be viewed. Detachable folding legs are stored in the case when they are not in use.

U.S. Pat. No. 4,451,728, issued to McKay et al. discloses a portable voting including a surface for supporting a paper ballot or for pivotally securing a tray for receiving a vote recording machine. The surface on the lower portion of the device is far too small to enable a set of construction plans to be spread out and viewed. In addition, there are no compartments to store pens, pencils, rulers and the like.

### SUMMARY OF THE INVENTION

The present invention is directed to a portable table and carrier device for transporting and reading construction plans (e.g. blueprints). The device includes a table having a plan storage compartment for holding one or more sets of construction plans in a flat or folded position. The storage compartment is flush with the surface of the table thus enabling the construction plans to be written on without problems from the underlying surface. A lid is hinged to the storage compartment and the table thus providing access to the storage compartment when open and a smooth work surface for the table when closed. The lid also protects the contents of the storage compartment when it is closed. Binder clips at opposite ends of the portable secure the set of construction plans in place for viewing and modification. The binder clips holds the turned pages of the plans, thereby permitting individual pages of the plans to be easily viewed while the entire set of plans is secured in place and held open to the selected page.

A recessed area on the underside of the table accommodates a set of folding leg members, while the other set of leg members is held adjacent to outer perimeter of the table. Both sets of leg members are operable between a collapsed position and an extended position to support the table in a horizontal, elevated position above the floor or ground, thereby providing a table for conveniently reading the plans. With the legs extended, the device can be used as a portable table for other purposes, such as eating meals, typing on a laptop computer or doing paperwork. A carry handle and shoulder strap can be provided on the main body of the table for ease of carrying and transport.

Accordingly, it is an objective of the instant invention to provide a device for carrying a set of construction plans, or multiple sets of plans, within a protective compartment which keeps the plans concealed and dry, and wherein the device is also a table to facilitate ease of reading the plans at a construction site or other field location.

It is a further objective of the instant invention to provide a device which protectively carries one or more sets of construction plans, and wherein the device includes folding legs to enable the device to be set up as a table at a construction site or other field location.

It is yet another objective of the instant invention to provide a device for carrying one or more sets of construction plans, and wherein the device includes a plan storage compartment and hinged lid for covering and protecting the plans during transport and further wherein the device includes binder clamps for securing the plans flat and in readable position.

It is a still further objective of the invention to provide a device including a portable table and carrier for construction plans which protectively conceals one or more sets of construction plans during non-use and transport and further wherein the device facilitates the ease of reading construction plans in harsh indoor and outdoor construction environments.

It is still a further object of the present invention to provide a device for protectively carrying one or more sets of construction plans, as set forth above, and further wherein the device includes a protective compartment for holding items such as, but not limited to, pens, pencils, rulers, calculators, a pencil sharpener, a magnifier and other such items which are commonly used by architects, general contractors and sub-contractors when reading and modifying construction plans at a construction site.

It is still a further objective of the present invention to provide a portable table and carrier for construction plans, as set for the above, which is lightweight and relatively compact in size to facilitate ease of carrying with the use of a handle and/or a shoulder strap.

It is yet a further objective of the present invention to provide a portable table and carrier for construction plans which is easily transportable and moveable to different locations, such as from one floor to another floor of a building under construction.

It is still a further object of the present invention to provide a portable table and carrier for construction plans as set for the above, which is of durable and rugged construction.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top perspective view of the portable table and plan carrier of the present invention;

FIG. 2 is a top view of the portable table and plan carrier of the present invention;

FIG. 3 is a side view of the present invention with the legs extended and supporting the table;

FIG. 4 is a top view of another embodiment of the present invention including a carrying handle;

FIG. 5 is a perspective view of one of the plugs of the present invention; and

FIG. 6 is a perspective view of one of the binder clips of the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated. The scope of the invention is defined by the claims appended hereto.

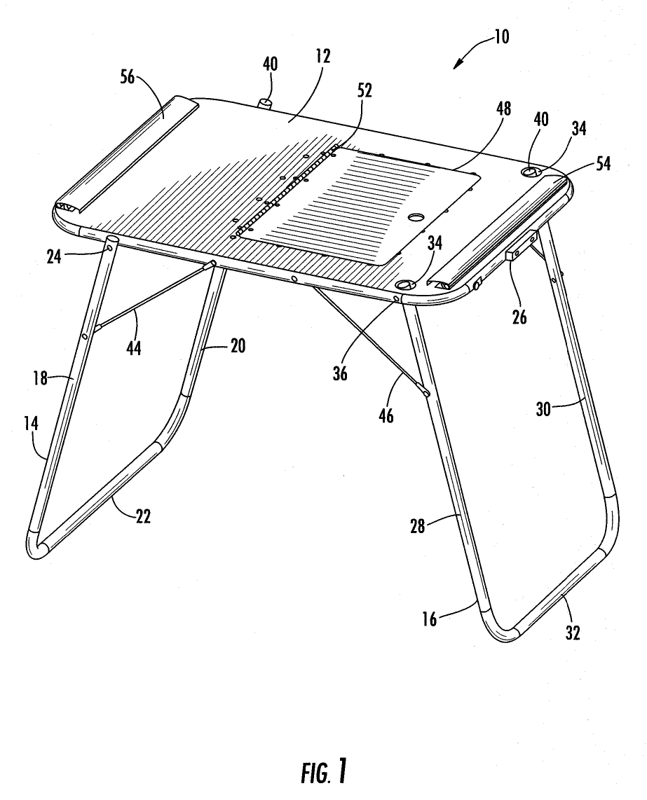

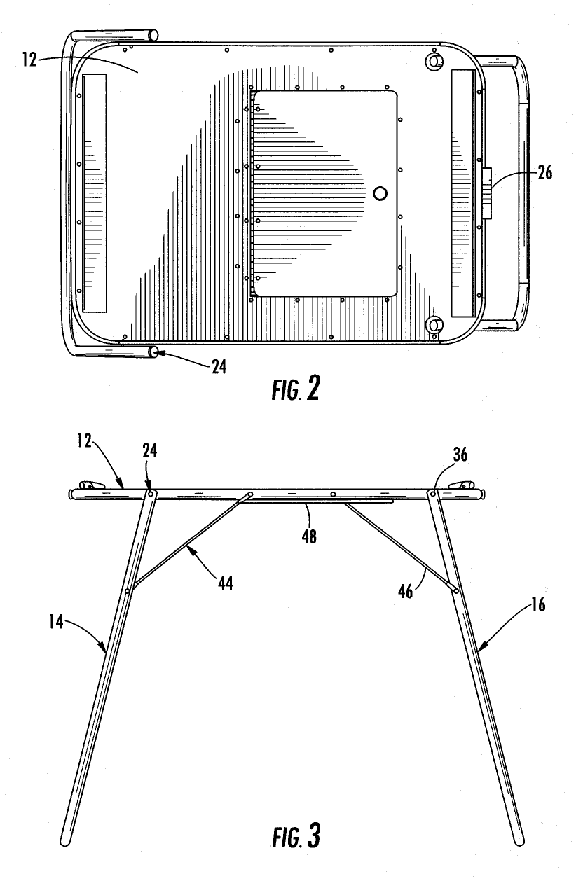

Referring to the several views of the drawings and initially to FIGS. 1-4, the portable table and construction plan carrier device of the present invention is shown generally as 10. The table comprises a generally flat, rectilinear upper surface 12 which also serves as the working surface of the table. The upper surface 12 has a front edge 13, a rear edge 15, and side edges 17 and 19 respectively. The upper surface is supported in a substantially horizontal position above an underlying floor surface by leg members 14 and 16. Each of these leg members is formed as a U shape and includes a pair of legs connected by a member. Leg member 14 includes legs 18 and 20 which are connected at one end by member 22. Leg member 14 is pivotally secured to opposite outer edge portions of table surface 12 by pivotal securing members 24. This enables the leg member 14 to be folded upwardly to a storage or collapsed position juxtaposed the outer edge of the table 10. A retention member 26 (FIGS. 1 & 2), attached to side edge 19 of surface 12, engages member 22 to hold leg member 14 in its collapsed or stored position. Leg member 16 includes legs 28 and 30 which are connected at one end by member 32. Leg member 16 is pivotally secured to the underside of table surface 12 at recesses 34 by pivotal securing members 36. This arrangement enables leg member 16 to be folded upwardly to a storage or collapsed position against the underside of table surface 12, thereby concealing the leg member within a recessed area of the underside of table 10. When leg members 14 and 16 are in their folded, collapsed position they are within a recess of the underside of surface 12 and juxtaposed the perimeter edge of surface 12 thereby providing a low profile structure for ease of transport or storage. Leg members 14 and 16 comprise hollow tubular members in a preferred embodiment, but could also be formed from other materials. The portable table 10 and construction plan carrying device can be made from aluminum, an aluminum alloy or other similar light weight materials.

The open ends of the leg members 14 and 16 are provided with plugs 38 which are inserted thereinto. Plugs 38 include an upper cylindrical portion 40 which is larger in diameter than the main body of the plug. This portion serves to abut the open end of the leg members and prevent the plug from being inserted to far into the leg member. The plugs are also provided with passages 42 to accommodate the pivotal securing members 24 and 36 which secure the leg members to the table surface 12. In place of the passages, slots could also be provided so that the plugs can be attached to the leg members after the leg members are secured to the table surface.

When leg members 14 and 16 are folded down to their extended position, the device 10 is converted to a table with an upper surface 12. Brace members 38 and 40 are secured to leg members 14 and 16 respectively. The brace members are also secured to the table surface 12 along the peripheral edges, as illustrated in FIGS. 1 and 3. Each leg member is secured to the table surface by two brace members, although only one is shown. The brace members 44 and 46 are flexible wires in a preferred embodiment, but could also be any other conventional pivotal brace member including folding braces.

The upper surface of the table includes a storage compartment or carrying case 48 for the storage of construction plans, pen, pencils, rulers, calculators, and the like. The construction plans and all the items that a general contractor or sub-contractor would need on a job site to view and/or modify the construction plans are stored in compartment 48. Compartment 48 extends below the upper surface of table 10 as can be seen in FIG. 3. A door 50 is hingedly secured to storage compartment 48 as illustrated in FIGS. 1, 2 and 4. The door 50 provides access to the compartment 48 when open and retains the materials within the compartment when it is closed. The door 50 also forms a portion of the upper surface 12 of table 10. The door is formed flush with the upper surface 12 such that there is not a discernable difference in the surface where the periphery of door 50 abuts surface 12. This enables a person to write on a construction plan or piece of paper laid across the junction of the door and the surface without affecting the writing. The junction of door 50 and the upper surface 12 is also formed as a waterproof junction whereby construction plans stored in compartment 48 are maintained dry at all times. Hinge 52 provides the hinged connection between the door 50 and the table surface 12. Hinge 52 is also positioned flush with the upper surface 12 to enable construction plans to be easily read and modified thereupon. There is also no discernable distinction between the door 50, hinge 52 and upper surface 12 at the junction thereof. Although a piano hinge is illustrated in a preferred embodiment, any other type of hinge can also be employed, such as a living hinge. The depth of storage compartment 48 can vary depending on the number and size of the items to be stored therein. Thus, one of the key features of the present invention is a portable table having a flat surface including an access door to a storage compartment and upon which construction plans or other written materials can be examined and modified by writing or drawing thereon.

The upper surface 12 of table 10 is also provided with clamps 54 and 56 located at opposite end portions thereof. Binder clamps 54 and 56 are designed to secure a set of construction plans to the upper surface 12 so that they may be examined. When the pages of the plans need to be turned one of the clamps is momentary opened to release the turned page and then clamped down on the remaining pages. The opposite clamp is then momentary open, the turned page is inserted into the clamp on top of the other pages in the clamp and the clamp is then closed thus securing the pages to the table. Both of the clamps 54 and 56 are similar in construction so that only one will be described herein. Referring now to FIG. 6, a clamp includes an upper clamp member 58 and a lower clamp member 60. These elements are hingedly connected to each other at 62. While a simple pivot and groove hinge is illustrated, any other type of hinge is also contemplated, such as a living hinge. A plurality of leaf springs 64 maintain the clamps in theirs closed positions. When a clamp is opened to release or insert a page therein, the upper member is pivoted upwardly at its free end. This action places the springs 64 under tension. When the free end of upper member 58 is released the springs 64 force member 58 to its close position against lower member 60. This force also enables the clamps to retain the construction plans or other papers placed therein. Longitudinally extending members 66 and 68 on upper member 58 engage the construction plans to hold them within the clamp. The member 66 and 68 extend from upper member 58 different distances so that they can engage stacks of papers of differing heights with approximately the same force. Member 70, on the lower clamp member 60, performs the same function as members 66 and 68. Clamps 54 and 56 may be secured to the upper surface 12 by any suitable means.

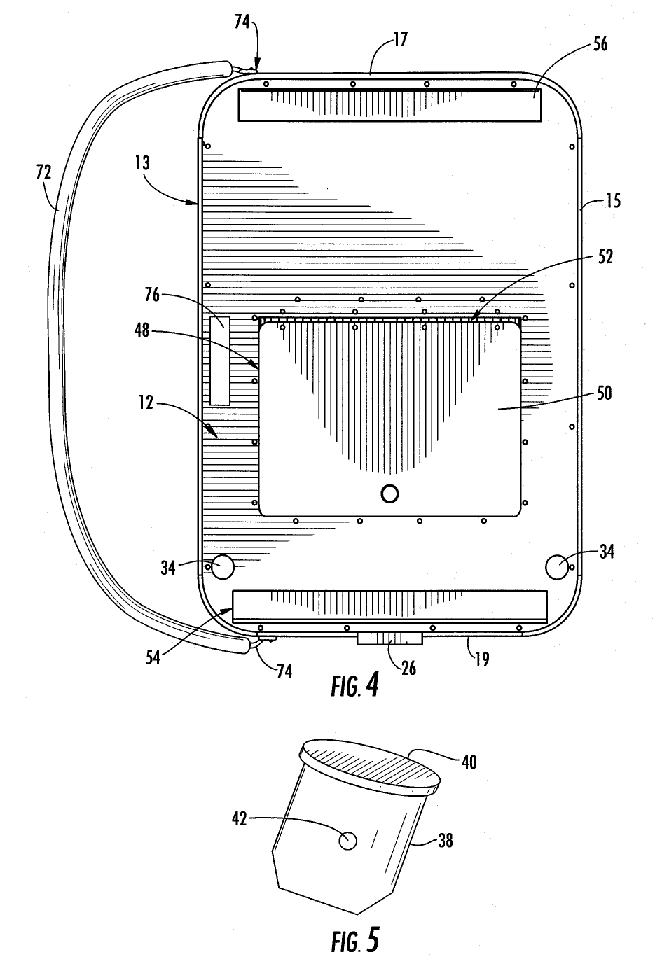

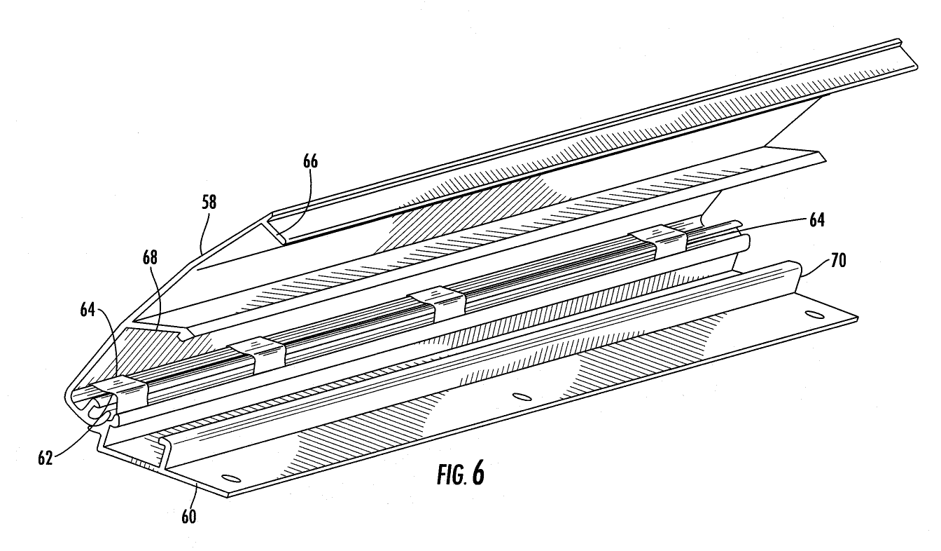

An adjustable strap 72 is attached to opposite ends of table 10 by clips 74. The strap is adjustable so that the table with the legs folded therein can be readily carried over a person's shoulder. This enables the table to be readily transported from one location to another at a construction site. The clips 74 can be the spring biased type so that they can be readily removed from the table. A cutout forming a handle 76 may optionally be formed into the upper surface 12 of table 10 as illustrated in FIG. 4. This handle also enables the table to be readily moved from one location to another.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A combination portable table and construction plan carrying case comprising:
table having a rectilinear upper surface, said upper surface bordered by front, rear and opposing side edges;
compartment sized and arranged to accommodate at least one full set of construction plans formed in the upper surface of said table, said compartment including a door hingedly connected to said compartment and closing said compartment, said door also forming a portion of said upper surface of said table, said door being fit into said upper surface of said table such that there is no noticeable distinction between said door and said upper surface of said table, said compartment having front rear and side edges respectively parallel to said front, rear and side edges of said upper surface;
said upper surface having first and second binder clamps mounted there on proximate said opposing edges of said upper surface, said binder clamps configured to secure construction plans to said upper surface; and
two sets of folding leg members pivotally attached to said upper surface, said two sets of folding legs positionable between a collapsed position adjacent said upper surface and an extended position whereby said upper surface is supported in a substantially horizontal position relative to an underlying support surface.

2. The combination portable table and carrying case of claim 1, including a hinge connecting said door and said upper surface and there is no discernable distinction between said door, said hinge and said upper surface at the junction thereof.

3. The combination portable table and carrying case of claim 2, wherein said hinge is a living hinge.

4. The combination portable table and carrying case of claim 1, wherein said first and second binder clamps comprise elongated structures mounted parallel to said opposing side edges of said upper surface.

5. The combination portable table and carrying case of claim 4, wherein at least one of said first and second binder clamps can be selectively opened and closed whereby said first binder clamp secures a binding of a set of construction plans and said second binder clamp secures loose pages of the construction plans.

6. The combination portable table and carrying case of claim 4, wherein said binder clamps include an upper and a lower member, said upper and lower clamp members are pivotally connected along one edge portion of each of said clamp members, a spring connected to said upper and said lower clamp members and biasing said clamp members to a closed position.

7. The combination portable table and carrying case of claim 1, wherein the bottom side of said upper surface includes a recess therein configured to receive a set of said folding leg members in said collapsed position.

8. The combination portable table and carrying case of claim 7, wherein said other set of said folding legs is positioned adjacent an outer periphery of said upper surface in said collapsed condition and said side edge of said upper surface includes a retention member holding said leg set in said collapsed condition.

9. The combination portable table and carrying case of claim 1, wherein said sets of folding leg members are tubular and including a plug positioned in at least one open end of said tubular folding leg member.

10. The combination portable table and carrying case of claim 1, wherein said two sets of folding leg members are each unitary U-shaped structures.

11. The combination portable table and carrying case of claim 1 including a strap attached to said opposite edges of said table, said strap being constructed and arranged to enable said table to be readily transported from one location to another by a person.

12. The combination portable table and carrying case of claim 1, including a carrying handle formed in said upper surface, said handle being constructed and arranged to enable said table to be readily transported from one location to another by a person.

13. The combination portable table and carrying case of claim 1, wherein said portable table and carrying case are made of aluminum.
